(19) United States
(12) Patent Application Publication
(10) Pub. No.: US 2001/0043476 A1
(43) Pub. Date: Nov. 22, 2001

(54) HEADLIGHT FOR VEHICLE

(76) Inventor: CHRISTIAN LIETAR, MORGES (CH)

Correspondence Address: STRIKER STRIKER & STENBY, 103 EAST NECK ROAD, HUNTINGTON, NY, 11743

(21) Appl. No.: 09/329,815

(22) Filed: Jun. 10, 1999

(30) Foreign Application Priority Data
Jun. 19, 1998 (DE) 198 27 367.3

(51) Int. Cl. F21V 7/00

(52) U.S. Cl. 362/518; 362/517; 362/297; 362/346

(57) ABSTRACT

A headlight for vehicles said a light source; a reflector which reflects a light emitted by the light source so that a horizontal dispersion is provided, the reflector having a reflection surface which has at least two facets adjoining one another in a horizontal direction and bordering in a separating line, the separating line in a central plane of the reflector which contains an optical axis having at least approximately vertical tangent, the separating line having a course which deviates from a vertical so that regions of two adjoining facets located at least approximately in a joint horizontal plane near its separating line produce images of the light source which are arranged in a vertical direction at least approximately at a same height.

### BACKGROUND OF THE INVENTION

The present invention relates to a headlight for vehicles.

One of such headlights is disclosed for example in U.S. Pat. No. 4,916,585. This headlight has a light source and a reflector, by which the light emitted by the light source is reflected so that it has a horizontal dispersion.

A reflection surface of the reflector is subdivided into a plurality of facets arranged near one another in a horizontal direction and adjoining one another along separating lines. The separating lines extend vertically and the facets are formed so that they contain parabolas in vertical sections and ellipses in horizontal sections. With this vertical extension of separating lines between the facets, an offset of images of the light source produced by the adjoining facets in a vertical direction takes place. In particular, with the use of a headlight for producing a low beam or a fog beam, in which a bright-dark limit is required in predetermined position, this vertical offset of the images of the light source leads to the fact that either the images of the light source are located above the bright-dark limit and thereby a glare can be caused, or at a distance under the bright-dark limit, whereby the bright-dark limit is unclearly represented. In general, this vertical offset of the images of the light source negatively affects the illumination intensity distribution produced by the headlight.

### SUMMARY OF THE INVENTION

Accordingly, it is an object of the present invention to provide a headlight for vehicles, which avoids the disadvantages of the prior art.

In keeping with these objects and with others which will become apparent hereinafter, one feature of present invention resides, briefly stated, in a headlight for vehicles in which the separating line in the region of the horizontal plane of the reflector which contains the optical axis has at least approximately vertically extending tangent, and the separating line has a course which deviates from a vertical, so that with the regions of two adjoining facets near their separating line located at least approximately in a joint horizontal plane, images of the light source are produced which are arranged in a vertical direction at least approximately at a same height.

When the headlight for the vehicles is designed in accordance with the present invention, it has the advantage that due to the course of the separating lines between the facets which deviates from the verticals, no or at least a little deviation of the arrangement of images in a vertical direction reflected by the adjoining facets is provided.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a headlight in a simplified illustration, in a vertical longitudinal section;

FIG. 2 is a view showing a measuring screen arranged in front of the headlight during illumination by the light produced by the reflector;

FIG. 3 is a view showing a reflector of a headlight in a front view with a subdivision in facets;

FIG. 4 is a view showing an enlarged portion of the reflector of FIG. 3 identified with IV;

FIG. 5 is a measuring screen which is arranged in front of the headlight with images of a light source produced by the portion of the reflector of FIG. 4;

FIG. 6 shows a reflector in a front view in accordance with the first embodiment of the invention;

FIG. 7 is a view showing a reflector in a front view in accordance with a second embodiment of the invention.

### DESCRIPTION OF PREFERRED EMBODIMENTS

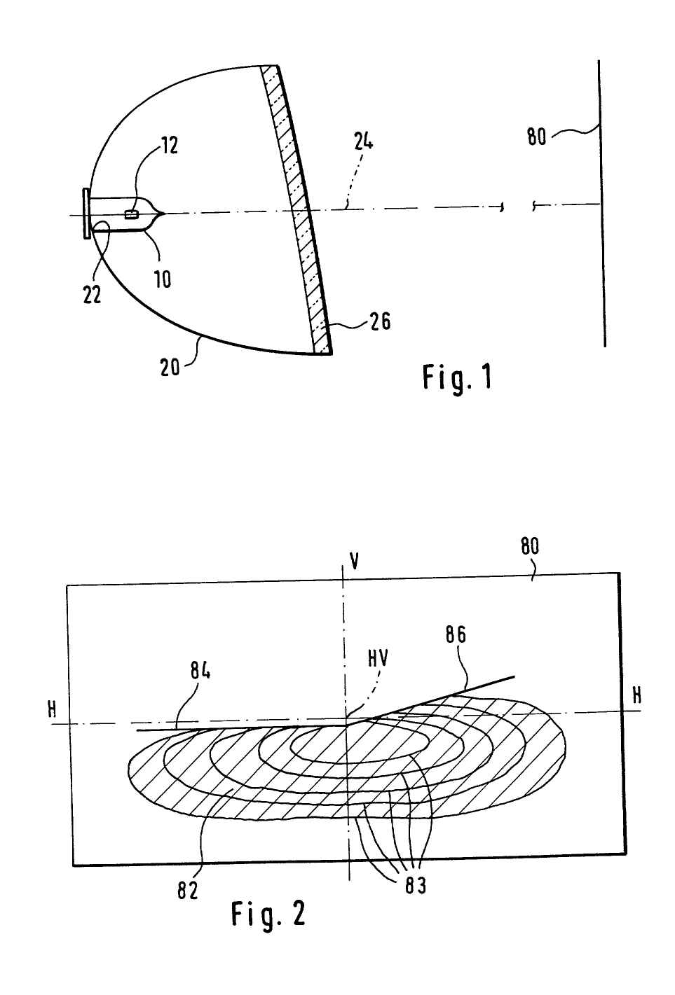

A headlight for vehicles, in particular motor vehicles, is shown in a simplified embodiment in FIG. 1. It serves for producing a low beam. Alternatively, the headlight can be used also for producing a high beam or a fog beam. The headlight has a light source 10 which can be an incandescent lamp or a gas discharge lamp. With the use of an incandescent lamp as the light source 10, it has a light body 12 formed as an incandescent coil. With the use of a gas discharge lamp as the light source 10, during its operation a light arc is formed between two electrodes as the light body 12.

The headlight moreover has a reflector 20. The reflector is concavely curved and has an opening 22 in an apex region in which the light source 10 is inserted. The optical axis of the reflector 20 is identified with reference numeral 24 and extends coaxially to the opening 22. The reflector 20 can be composed of metal or synthetic plastic and has a reflecting coating on its front side. The light body 12 of the light source 10 is arranged at least approximately parallel to the optical axis 24 of the reflector 20. The light outlet opening of the headlight is covered with a light-permeable disk 26 composed of glass or synthetic plastic. It has no optical profiles, so that the light reflected by the reflector 20 passes through the disk without being affected. The cover disk 26 can be arranged perpendicular to the optical axis 24 or inclined and/or tilted in any other way.

During the designing of the shape of the reflection surface of the reflector 20, at least a continuous surface is determined for it, by which the light emitted by the light body 12 of the light source 10 is reflected so that it produces at least approximately an illumination intensity distribution which is suitable for the low beam. The shape of the reflector 20 thereby is determined from the illumination intensity distribution to be produced, which is provided by a super positioning of the images of the light body 12 of the light source 10 reflected by the reflector 20. From the required position of the images of the light body 12, for a plurality of partial regions of the reflector 20 their orientation can be determined. The partial regions can be connected with one another to form a continuous surface, which forms the reflection surface of the reflector 20.

A measuring screen 80 is arranged in front of the reflector at a distance from it as shown in FIG. 2. It is illuminated by the light which is emitted by the light body 12 of the light source 10 and reflected by the reflector 20. The vertical central plane of the measuring screen 80 is identified with W and its horizontal central plane is identified with HH. The vertical central plane VV and the horizontal central plane HH intersects in a point HV. The measuring screen 80 is illuminated in the region 82 by the low beam light exiting the headlight. The illumination intensity distributions in the region 82 are identified with several lines 83 which have identical illumination intensities, or so-called isolux lines.

In the shown embodiment, the headlight is designed for a right traffic in accordance with the regulations existing in Europe. The region 82 at the left side of the measuring screen 80 which is a counter traffic side, is limited from above by a portion 84 of a bright-dark limit which extends substantially horizontally under the horizontal central plane HH. At the right side of the measuring screen 80, which is a traffic side itself, the region 82 is limited from above by a portion 86 of a bright-dark limit which raises to the right from the horizontal portion 84. The highest illumination intensities are located in the region 82 in a zone under and right of the point HV.

It is however difficult with a reflector 20 having a continuous reflecting surface and with a cover disk 26 without optical profiles to obtain the desired illumination intensity distribution with good homogenity, or in other words without undesired local maxima or minima of the illumination intensity. Also a local concentration of the reflected light on the cover disk 26 may occur. Especially in the case of the cover disk 26 composed of synthetic plastic, it can be critical and can lead to strong heating and eventual deformation of the cover disk 26.

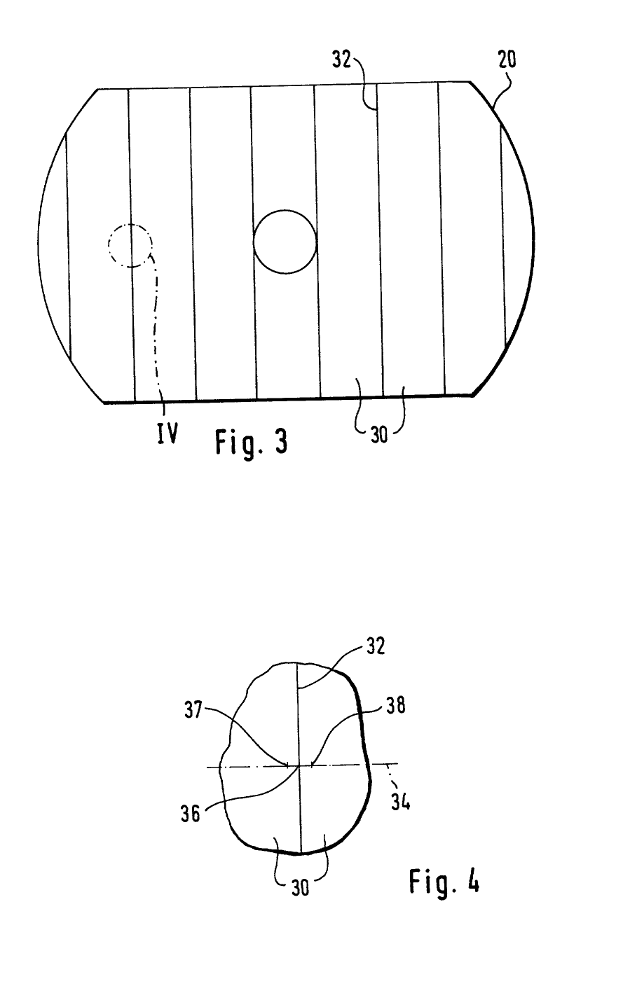

In order to avoid such undesired maxima and minima of the illumination intensity the reflection surface of the reflector, starting from the above described predetermined continuous surface, is subdivided into a plurality of facets 30. Light is reflected by it in a different manner than by the original continuing reflecting surface. FIG. 3 shows a reflector 20 on a front view, in which the reflection surface is subdivided into several facets 30 arranged near one another in a horizontal direction. The facets 30 adjoin one another over separating lines 32 which extend in a projection perpendicular to the optical axis 24 substantially vertically.

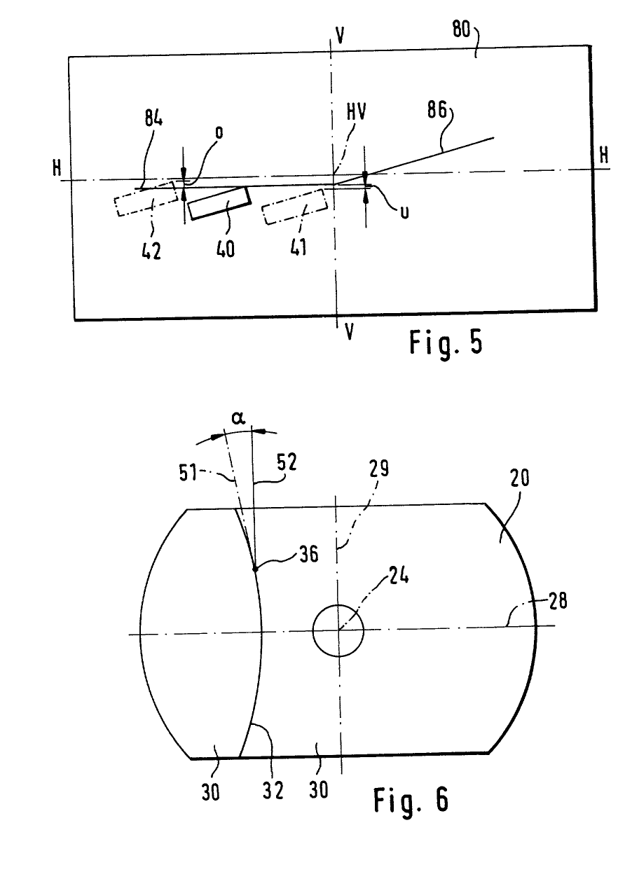

FIG. 4 shows on an enlarged scale a portion of the reflection surface of the reflector 20, with two facets 30 bordering one another in separating line 32. Three points are marked in FIG. 4, which are located in a common horizontal plane 34. A point 36 is located on the separating line 32, a point 37 is located on the left facet 30 near the separating line 32, and the point 38 is located on the right facet 30 near the separating line 32. Basically the point 36 is located in a tangential plane to the original continuous reflection surface. FIG. 5 shows a measuring screen 80 which is arranged at a distance from the reflector 20 forwardly of it. An image 40 of the light body 12 is produced on the measuring screen 80 by the point 36. It is arranged for example at the left side of the measuring screen 80 under the horizontal portion 84 of the bright-dark limit and is located with its highest point substantially on the portion 84. An image 41 of the light body 12 is produced on the measuring screen 80 by the point 37. It is offset in a horizontal direction to the image 40 and is arranged near the vertical central plane VV of the measuring screen 80. An image 41 produced by the point 37 is arranged under the portion 84 of the bright-dark limit. Its highest point is located with a distance u under the portion 84.

An image 42 of the light body 12 is produced by the point 38 on the measuring screen 80, which is offset in a horizontal direction relative to the image 40 and arranged further from the vertical central plane Vv of the measuring screen 80. The image 42 which is produced by the point 38 is arranged only partially under the portion 84 of the bright-dark limit, and its highest point is located at a distance o above the portion 84. The distance between images 40, 41 and 42 of the light body 12 in a horizontal direction along the portion 84 of the bright-dark limit is desired so as to provide the illumination intensity distribution with a sufficient width. The offset of the images 40, 41, 42 of the light body 12 in a vertical direction is however not desired, since the image 42 of a screen can be caused to extend over the portion 84 of the bright-dark limit. Thereby the image 41 arranged at a distance under the portion 84 leads to the situation that the bright-dark limit is not sharp.

The offset of the images 40, 41 and 42 in a vertical direction can be avoided or at least made smaller, when the points 37 and 38 are arranged in the horizontal central plane 28 of the reflector 20 which contains the optical axis 48, or at least near it, or when the image 40 of the light body 12 produced by the point 36 of the separating line 32 is substantially centered to the vertical central plane W of the measuring screen 80. In the last case, however, the illumination intensity distribution produced by the reflector 20 with the original continuous reflection surface is concentrated around the vertical central plane W of the measuring screen 80 and does not have a sufficient horizontal width. The required horizontal width of the illumination intensity distribution must be obtained then by the facets 30. It is however desired that with the reflector 20 having the original continuous reflection surface, an illumination intensity distribution with a sufficient horizontal width is produced. For this purpose it is necessary to produce images of the light body 12 by the original continuous reflection surface of the reflector such that they are spaced from one another in a horizontal direction. By the distribution in the facets, then substantially a homogenization of the illumination intensity distribution is provided.

In order to avoid the undesired offset of the images 41 and 42 of the light body 20 in the vertical direction with regard to the image 40, so that they are arranged at least approximately at the same height, in accordance with the present invention the separating light 32 between the adjoining facets 30 extends not vertically as in FIGS. 3 and 4, but instead deviates from the verticals. FIG. 6 shows the reflector in a front view in accordance with a first embodiment of the present invention. In the region of the horizontal central plane 28 of the reflector 20 which contains the optical axis 24, the separating line 32 extends so that it is arranged substantially vertically on a tangent. With increasing distance from the horizontal central plane 28 of the reflector 20, the separating line 32 extends deviatingly from the vertical. The tangent 51 lying on an exemplary point 36 which is arranged at a vertical distance from the horizontal central plane 28 on the separating line 32, extends with regard to the vertical 52 under an angle α.

The angle α is substantially proportional to the distance of the point 36 in a vertical direction from the horizontal central plane 28 when the distance of the image 40 in a horizontal direction from the vertical central plane of the measuring screen 80 remains constant. The angle α is also substantially proportional to the distance of the center of the image 40 in a horizontal direction from the vertical central plane VV of the measuring screen 80, when the point 36 remains constant. When the image 40 is arranged at the right side of the measuring screen 80, the curvature of the separating line 32 extends in an opposite direction. The separating line 32 extends on the outer surface of a cylinder, whose surface lines extend at least substantially parallel to the optical axis 24 of the reflector 20. The cylinder can be an irregular cylinder or approximately a circular cylinder. In transverse sections through the cylinder perpendicularly to the optical axis 24, its outer surface is represented by the separating line 32 as an intersecting curve. The separating line 32 forms thereby a guiding line for the course of the surface of the cylinder. The separating line 32 can be at least approximately a portion of the circular arc or a conical curve, for example a parabola, an ellipse or a hyperbola. The course of the separating line 32 can be at least approximately symmetrical relative to the horizontal central plane 28 of the reflector 20, so that the separating line 32 extends above and below the central plane 28 substantially equally. The separating line 32 extends in a region around the horizontal central plane 28 the closest to the vertical central plane 29 of the reflector 20 which contains the optical axis 24. With increasing distance from the horizontal central plane 28, the distance of the separating line 32 from the vertical central plane 29 increases as well.

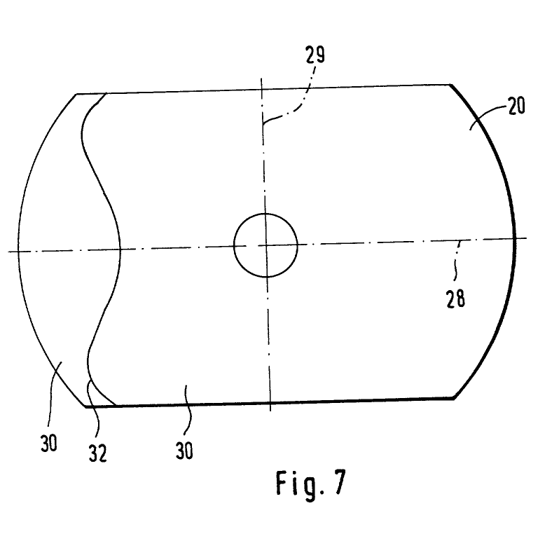

FIG. 7 shows the reflector 10 in a front view in accordance with the second embodiment of the invention. The separating line 32 between two adjoining facets 30 of the reflector 20 has a more complex course than the separating line 32 of FIG. 6. It extends in the region of the horizontal central plane 28 of the reflector 20 with a vertical tangent. With increasing distance from the horizontal central plane 28, first the distance of the separating line 32 from the vertical central plane 29 increases. After the upper and lower edge of the reflector 20, the separating line 32 of FIG. 7 however extends again with opposite curvature with regard to the vertical central plane 29. The separating line 32 of FIG. 7 extends at least approximately symmetrically to the horizontal central plane 28 of the reflector 20. The separating line 32 can have any other course, which is determined so that the adjoining facets 30 produce the images of the light body 12 which have no offset in a vertical direction.

The transition between the adjoining facets 30 in the separating line 32 is continuous in a first order. This means that no steps occur, but instead the facets 30 have the separating line 32 as a joint contact line. With the course of the separating line 32 which deviates from the vertical, a sharply pronounced bright-dark limit 84, 86 is obtained by the region 82 of the measuring screen 80 illuminated by the light bundle exiting the headlight. The facets 30 can be designed so that they provide no undesired light concentration and thereby heating of the cover disk 26. The reflection surface of the reflector 20 can be subdivided into two or more facets 30 arranged near one another in the horizontal direction. It can be also provided that the reflection surface of the reflector 20 is subdivided only locally in the facets 30, while in other regions a continuous reflection surface is available. The facets 30 can extend in a vertical direction continuously between the upper and lower edge of the reflector 20, or can be subdivided into further facet parts which adjoin one another in a vertical direction.

It will be understood that each of the elements described above, or two or more together, may also find a useful application in other types of constructions differing from the types described above.

While the invention has been illustrated and described as embodied in headlight for vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A headlight for vehicles, comprising a light source; a reflector which reflects a light emitted by said light source so that a horizontal dispersion is provided, said reflector having a reflection surface which has at least two facets adjoining one another in a horizontal direction and bordering in a separating line, said separating line in a central plane of the reflector which contains an optical axis having at least approximately vertical tangent, said separating line having a course which deviates from a vertical so that regions of two adjoining facets located at least approximately in a joint horizontal plane near its separating line produce images of said light source which are arranged in a vertical direction at least approximately at a same height.

2. A headlight as defined in claim 1, wherein said separating line is at least locally curved.

3. A headlight as defined in claim 1, wherein said separating line at least locally extends at least approximately in form of a portion of a conical curve.

4. A headlight as defined in claim 3, wherein said separating line at least locally extend at least approximately in form of a portion of a parabola.

5. A headlight as defined in claim 3, wherein said separating line extends at least locally at least approximately as a circular arc.

6. A headlight as defined in claim 1, wherein said separating line extends at least approximately symmetrically to a horizontal central plane of said reflector.

7. A headlight as defined in claim 1, wherein said facets have a transition provided in said separating line and being stepless.

8. A headlight as defined in claim 1, wherein said facets are formed so that the images of said light source have their highest points adjoining a bright-dark limit.
